(19) United States
(12) Patent Application Publication
(10) Pub. No.: US 2009/0136118 A1
(43) Pub. Date: May 28, 2009

(54) Electronic Device Handling Apparatus

(75) Inventor: Masayoshi Ichikawa, Tokyo (JP)

Correspondence Address: POSZ LAW GROUP, PLC, 12040 SOUTH LAKES DRIVE, SUITE 101, RESTON, VA, 20191, US

(73) Assignee: Advantest Corporation, Nerima-=ku Tokyo (JP)

(21) Appl. No.: 11/887,240

(22) PCT Filed: Apr. 11, 2005
(86) PCT No.: PCT/JP2005/007026

§ 371 Date: Sep. 27, 2007

(51) Int. Cl. G06K 9/00

(52) U.S. Cl. 382/145

(57) ABSTRACT

An electronic device handling apparatus for conducting a test of electric characteristics of electronic devices by conveying the electronic devices to sockets of a contact portion and bringing them electrically connected to the sockets: wherein standard image data as image data of sockets to be standard is stored in advance, and inspection image data as image data of sockets as inspection objects is obtained by taking an image by the image pickup device, standard image data is read from a memory device and a defect of a socket as inspection objects is detected by comparing the standard image data with the inspection image data.

### TECHNICAL FIELD

The present invention relates to an electronic device handling apparatus capable of detecting defects of sockets, such as wear and deformation of socket terminals and adhesion of dirt and foreign matter.

### BACKGROUND ART

In a production procedure of an electronic device, such as an IC device, an electronic device testing apparatus is used for testing performance and functions of a finally produced electronic device.

An electronic device testing apparatus as a conventional example is provided with a test section for conducting a test on an electronic device, a loader section for sending a pre-test IC device to the test section and an unloader section for taking out post-test IC device from the test section and classifying. The loader section is provided with a buffer stage capable of moving back and forth between the loader section and the test section and a loader section conveyor device having suction portions for holding IC devices by suction and capable of moving in a range from a customer tray to a heat plate and the heat plate to the buffer stage. Also, the test section is provided with a contact arm capable of holding IC devices by suction and pressing the same against sockets of a test head and a test section conveyor device capable of moving in a test section range.

The loader section conveyor device uses the suction portion to hold by suction IC devices held on a customer tray, loads the same on a heat plate, then, holds by suction the IC devices on the heat plate heated to a predetermined temperature again by using the suction portion and loads them on the buffer stage. Then, the buffer stage loaded with the IC devices moves from the loader section to the test section side. Next, the test section conveyor device holds by suction the IC devices on the buffer stage by using a contact arm and presses them against sockets of the test head to bring external terminals of the IC devices (device terminals) contact connection terminals of sockets (socket terminals).

In that state, a test signal supplied from a tester body to the test head via a cable is applied to the IC devices and, by sending a response signal read from the IC devices to the tester body through the test head and the cable, electric characteristics of the IC devices are measured.

However, as the test as above is repeated and the number of contact times of the device terminals and socket terminals increases, tip portions of the socket terminals are gradually worn out. When a degree of the wearing out becomes high, contact of device terminals with socket terminals becomes insufficient and electric resistance increases at the contact portion of the both terminals, so that a test on the IC device cannot be conducted accurately.

Also, respective socket terminals have to be processed and adjusted to be able to contact with all device terminals with a uniform force, and when the processing and adjustment are inadequate, disproportionate wearing may arise on the socket terminals. In that case, there arises a problem that a test relating to a disproportionately worn socket terminal cannot be conducted accurately.

Furthermore, when the number of contact times of the device terminals with socket terminals increases due to repetition of the test, solder, etc. of the device terminals gradually adheres to the socket terminals. Such dirt on the socket terminals also increases electric resistance at the contact portion, so that a test on IC devices cannot be conducted accurately.

Furthermore, when foreign matter or dirt, such as soldering ball, etc. dropped from IC devices adhere to the sockets, not only an accurate test becomes impossible, but when an IC device is pressed while foreign matter is adhered, there arise problems that bending or crushing arise on the socket terminals and device terminals are damaged.

Conventionally, sockets have been taken out from the test head and observed by a microscope, etc. regularly to inspect a condition of wear of the socket terminals and existence of foreign matter, etc.

### DISCLOSURE OF THE INVENTION

However, detachment and attachment of sockets and observation by a microscope, etc. takes enormous time and the test is suspended during that time, so that there has been a disadvantage that the test efficiency is largely declined.

The present invention was made in consideration of the above circumstances and has as an object thereof to provide an electronic device handling apparatus capable of automatically detecting defects of sockets.

To attain the above object, first, the present invention provides an electronic device handling apparatus for conducting a test of electric characteristics of electronic devices by conveying the electronic devices to sockets of a contact portion and bringing them electrically connected to the sockets, comprising an image pickup device for taking an image of the sockets; a memory device for storing standard image data as image data of the sockets to be a standard obtained by taking an image by the image pickup device; and a defect detection means for obtaining inspection image data as image data of sockets as inspection objects by taking an image by the image pickup device, reading standard image data from the memory device and detecting a defect of a socket as inspection objects by comparing the standard image data with the inspection image data (the invention 1).

According to the above invention (the invention 1), a defect of a socket can be automatically detected without requiring visual exterior inspection of sockets performed manually.

Preferably, the electronic device handling apparatus according to the above invention (the invention 1) furthermore comprises an alarm device, and the alarm device is activated when a defect of a socket as an inspection object is detected by the defect detection means (the invention 2).

According to the above invention (the invention 2), a defect of a socket can be surely notified to an operator and the defect part of the socket can be resolved.

The electronic device handling apparatus according to the above invention (the invention 1) may furthermore comprise a count means for counting the number of test times of electronic devices, and the image pickup device takes an image of sockets as inspection objects when the number of test times counted by the count means becomes a predetermined value or larger (the invention 3); or furthermore comprise a count means for counting the number of contact defects in tests, and the image pickup device takes an image of sockets as inspection objects when the number of contact defects counted by the count means becomes a predetermined value or larger (the invention 4). Note that “the number of test times” in the present specification may be a total number of electronic devices to be tested successively transferred to the sockets or the number of contact of the electronic devices with sockets (particularly, in the case where one electronic device contacts with sockets for a plurality of times in one transfer).

According to the above inventions (the inventions 3 and 4), it is possible to perform the defect detection step of sockets at predetermined timing of transferring or testing the electronic devices, for example, by assuming timing that a defect arises in sockets.

In the above invention (the invention 1), preferably, the defect detection means generates differential image data by performing difference processing on the standard image data and the inspection image data and performs threshold processing on the differential image data so as to detect a defect of a sockets as an inspection object (the invention 5). According to the invention, a defect of a socket can be detected efficiently.

In the above invention (the invention 5), preferably, the defect detection means performs pixel value correction of the standard image data by making it matched with the inspection image data before performing the difference processing (the invention 6). According to the invention, a defect of a socket can be detected with high accuracy and detection of a defect of a socket can be stabilized.

Preferably, the electronic device handling apparatus according to the above invention (the invention 1) furthermore comprises a conveyor device capable of holding an electronic device to be tested and pressing it against the sockets; and the image pickup device is attached to the conveyor device (the invention 7). According to the invention, it is unnecessary to provide a device for conveying an image pickup device separately.

Secondly, the present invention provides an electronic device handling apparatus for conducting a test of electric characteristics of electronic devices by conveying the electronic devices to sockets of a contact portion and bringing them electrically connected to the sockets, comprising an image pickup device for taking an image of all contact pins of the sockets; and a defect detection means for taking an image of all contact pins of initial sockets and storing as standard image data, taking all contact pins of sockets as inspection image data every time a predetermined number of test times comes, and detecting a defect of a socket based on the standard image data and the inspection image data (the invention 8).

According to the above invention (The invention 8), a defect of a socket can be automatically detected without visual exterior inspection of the sockets by manual operation.

In the above inventions (1 and 8), preferably, the defect detection means corrects brightness, so that brightness on the standard image data and brightness on the inspection image data side become approximately the same, then, obtains a brightness difference of corresponding pixel positions of the two, and determines a defect of the sockets based on an existence of a image part, wherein the obtained brightness difference exceeds a predetermined threshold value (the invention 9). According to the invention, a defect of a socket can be detected efficiently.

In the above inventions (1 and 8), preferably, when a defect of a socket is detected by the defect detection means, transfer of an electronic device to the defect socket is terminated while transfer of electronic devices to other normal sockets and tests thereon continue (the invention 10). According to the invention, even if a defective socket partially exists, tests can be continuously conducted only with normal sockets without interrupting the tests, so that an operation rate of the electronic device testing apparatus can be improved.

In the above inventions (1 and 8), preferably, the electronic device handling apparatus furthermore comprises a display device; an image of sockets is displayed on the display device; and information indicating a defect detected by the defect detection means is displayed by being superimposed on a position corresponding to the defect part of the image of the sockets (the invention 11). According to the invention, it is possible for an operator to perceive a condition of the defect part by the display device obviously at a glance.

### EFFECT OF THE INVENTION

According to the electronic device handling apparatus of the present invention, a defect of a socket can be automatically detected, so that visual exterior inspection of sockets by a manual operation becomes unnecessary and the test efficiency can be widely improved.

### BRIEF DESCRIPTION OF DRAWINGS

FIG. 1 is a plan view of a handler according to an embodiment of the present invention.

FIG. 2 is a sectional view from the side of a part of the handler according to the same embodiment (a sectional view along I-I in FIG. 1).

FIG. 3 is a view from the side of a movable head portion and an image pickup device used in the same handler.

FIG. 4A is a flowchart showing a socket inspection step of the same handler.

FIG. 4B is a flowchart showing a socket inspection step of the same handler.

FIG. 5 is a conceptual view of the socket inspection step of the same handler.

### EXPLANATION OF REFERENCES

1 . . . electronic device testing apparatus
10 . . . electronic device handling apparatus (handler)
30 . . . test section
301 . . . contact portion
301a . . . socket
301b . . . contact pin
310 . . . test section conveyor device
312 . . . movable head portion
314 . . . image pickup device
315 . . . contact arm
50 . . . loader section
60 . . . unloader section

### BEST MODE FOR CARRYING OUT THE INVENTION

Below, an embodiment of the present invention will be explained in detail based on the drawings.

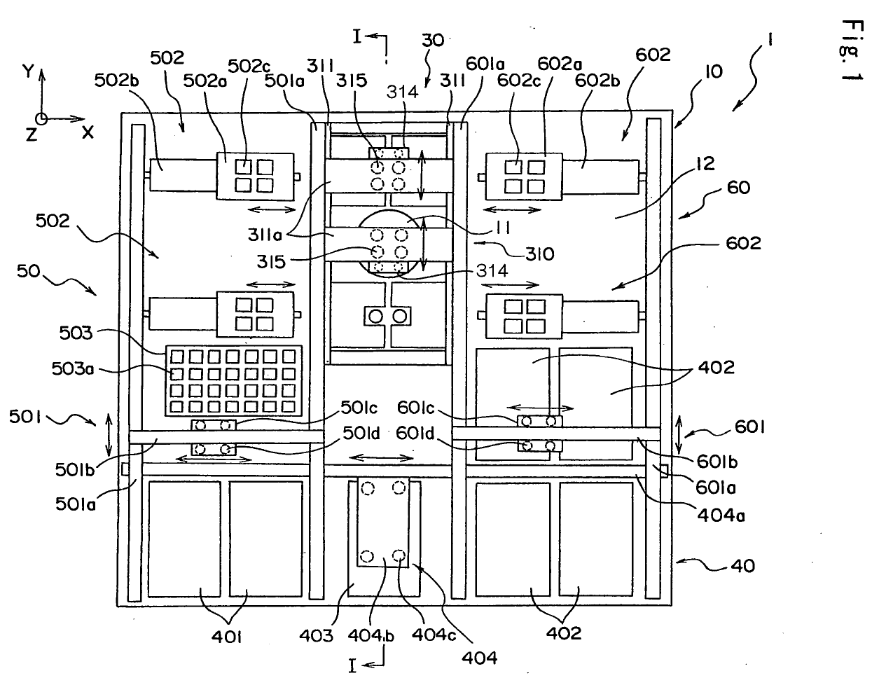

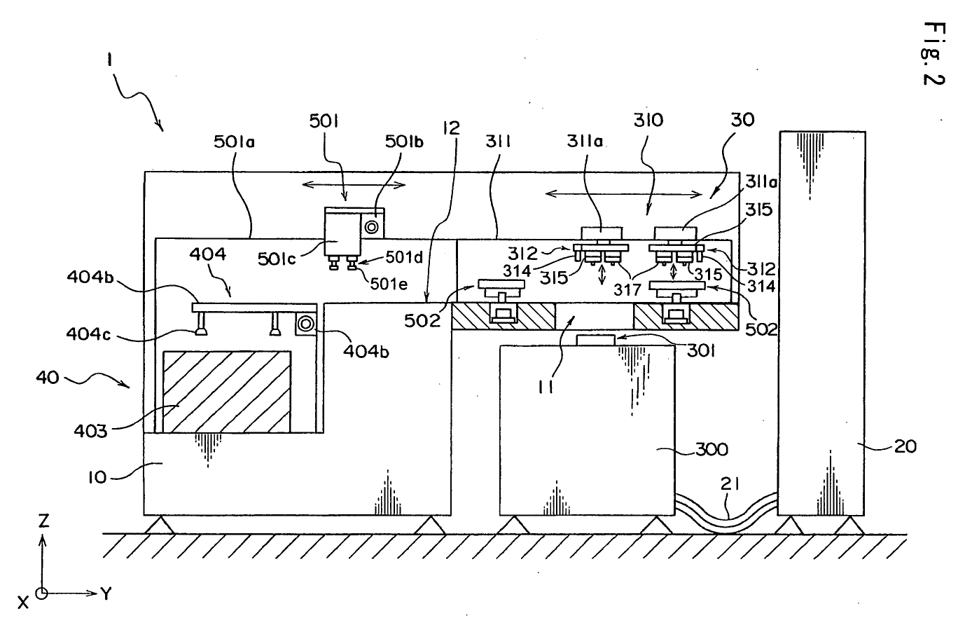

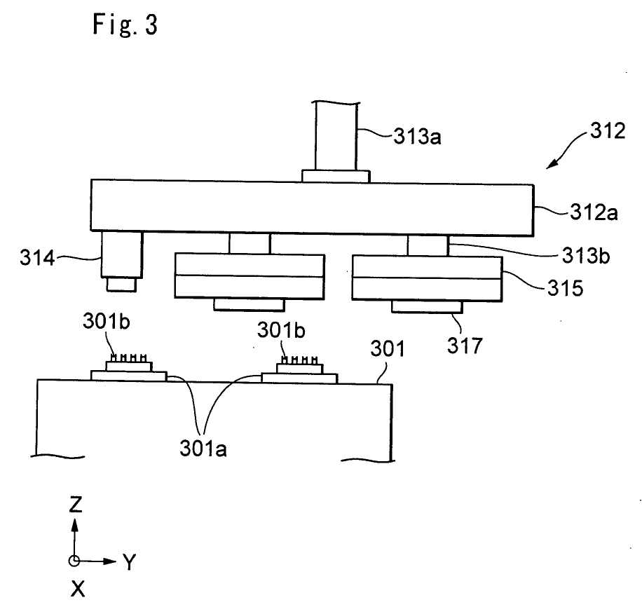

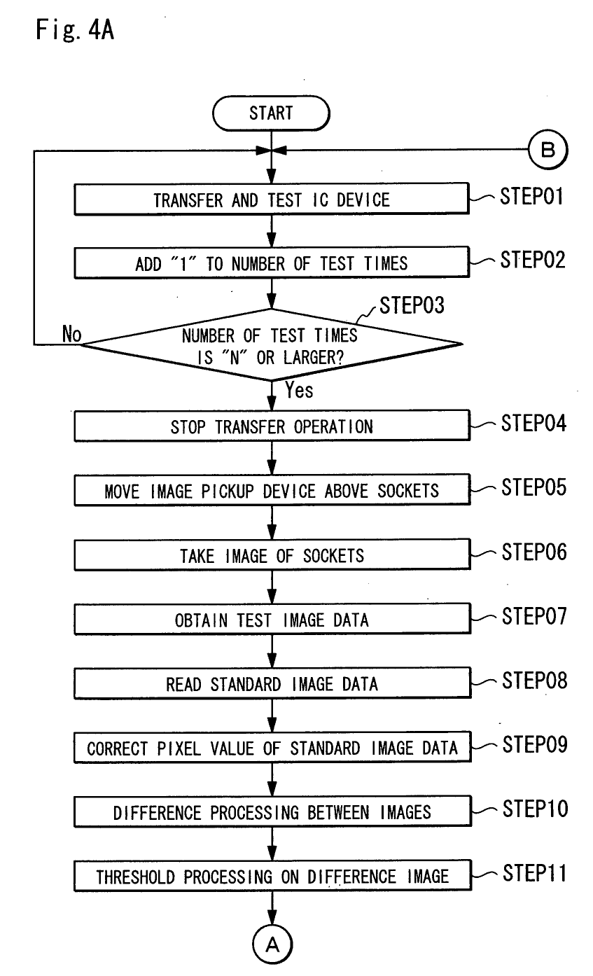

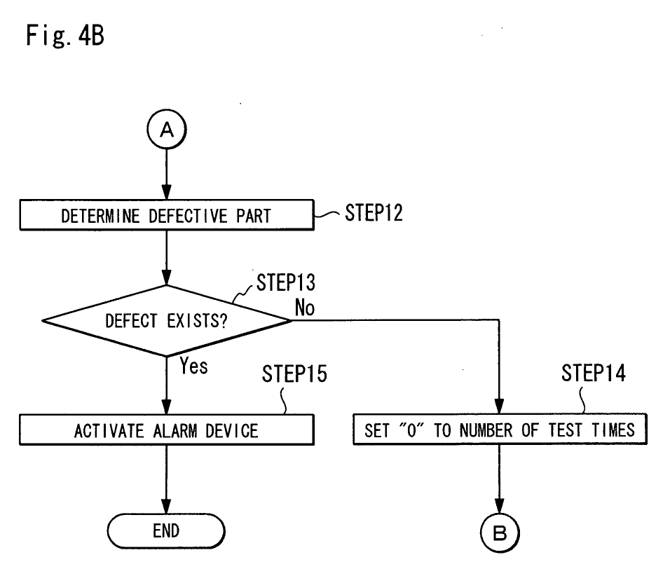

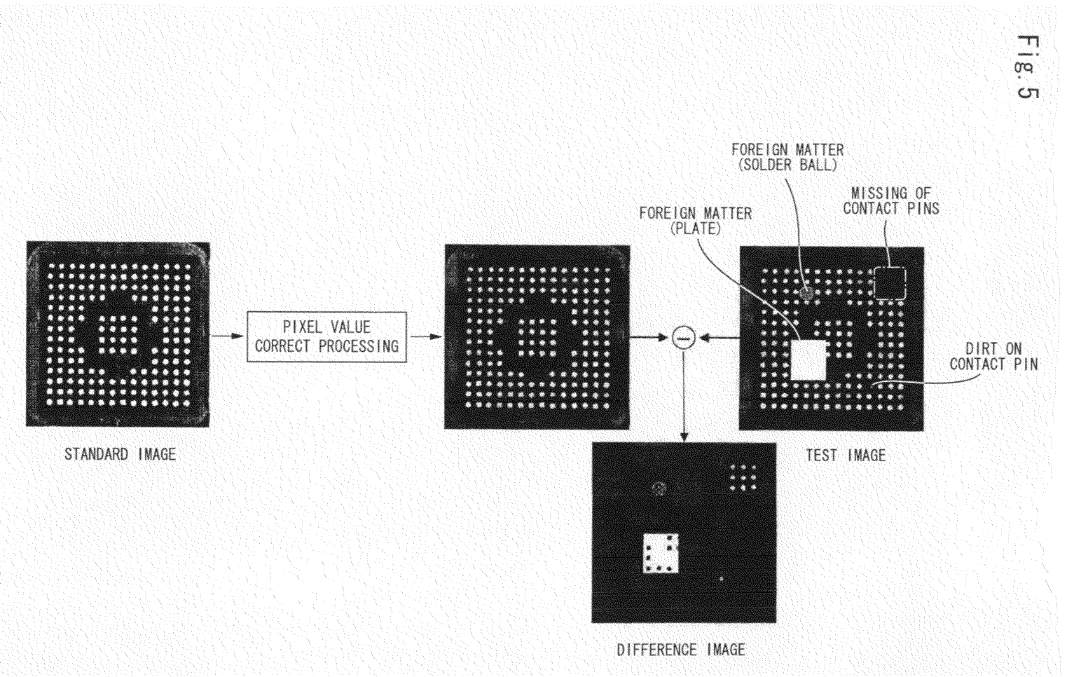

FIG. 1 is a plan view of a handler according to an embodiment of the present invention, FIG. 2 is a sectional side view of a part of the handler according to the same embodiment (a sectional view along I-I in FIG. 1), FIG. 3 is a view from the side of a movable head portion and an image pickup device used in the same handler, FIG. 4 are flowcharts showing a socket inspection step of the same handler and FIG. 5 is a conceptual view of the socket inspection step of the same handler.

Note that a form of an IC device to be tested in the present embodiment is assumed to be, as an example, a BGA package and a CSP (chip size package) provided with soldering balls as device terminals, etc. But the present invention is not limited to those and it may be, for example, a QFP (quad flat package) and SOP (small outline package) provided with lead pins as device terminals, etc.

As shown in FIG. 1 and FIG. 2, the electronic device testing apparatus 1 in the present embodiment comprises a handler 10, a test head 300 and a tester 20, wherein the test head 300 and the tester 20 are connected via a cable 21. Pre-test IC devices on a supply tray stored in a supply tray stocker 401 of the handler 10 are conveyed and pressed against sockets 301a of a contact portion 301 of the test head 300 and, after conducting a test on the IC devices via the test head 300 and the cable 21, the IC devices finished with the test are loaded on classification trays stored in a classification tray stocker 402 according to the test results.

The handler 10 is composed mainly of a test section 30, an IC device magazine 40, a loader section 50 and an unloader section 60. Below, each section will be explained.

IC Device Magazine 40

The IC device magazine 40 is a part for storing pre-test and post-test IC devices and mainly comprises a supply tray stocker 401, a classification tray stocker 402, an empty tray stocker 403 and a tray conveyor device 404.

In the supply tray stocker 401, a plurality of supply trays loaded with a plurality of pre-test IC devices are placed and, in the present embodiment, two supply tray stockers 401 are provided as shown in FIG. 1.

In the classification tray stocker 402, a plurality of classification trays loaded with a plurality of post-test IC devices are placed and, in the present embodiment, four classification tray stockers 402 are provided as shown in FIG. 1. By providing four classification tray stockers, it is configured that IC devices can be classified to four classes at maximum and stored in accordance with the test results.

The empty tray stocker 403 stores empty trays after supplying all pre-test IC devices 20 loaded on the supply tray stocker 401 to the test section 30. Note that the number of the respective stockers 401 to 403 may be suitably set in accordance with need.

The tray conveyor device 404 is a conveyor device movable in the X-axis and Z-axis directions in FIG. 1 and mainly comprises an X-axis direction rail 404a, a movable head portion 404b and four suction pads 404c. An operation range thereof includes the supply tray stockers 401, a part of the classification tray stockers 402 and the empty tray stockers 403.

In the tray conveyor device 404, the X-axis direction rail 404a fixed to a base 12 of the handler 10 supports the movable head portion 404b to be movable in the X-axis direction. The movable head portion 404b is provided with a not shown Z-axis direction actuator and, at its tip portion, four suction pads 404c.

The tray conveyor device 404 picks up and holds by the suction pads 404c an empty tray emptied at the supply tray stocker 401 and transfers them to the empty tray stocker 401 by elevating them by the Z-axis actuator and sliding the movable head portion 404b on the X-axis direction rail 404a. In the same way, when a classification tray becomes full with loaded post-test IC devices in the classification tray stocker 402, an empty tray is picked up from the empty tray stocker 403, held, and elevated by the Z-axis direction actuator and, by sliding the movable head portion 404b on the X-axis direction rail 404a, transferred to the classification tray stocker 402.

Loader Section 50

The loader section 50 is a part for supplying pre-test IC devices from the supply tray stocker 401 of the IC device magazine 40 to the test section 30 and mainly comprises a loader section conveyor device 501 and two loader buffer portions 502 (two in the X-axis negative direction in FIG. 1) and a heat plate 503.

The loader section conveyor device 501 is a device for moving IC devices on a supply tray of the supply tray stocker 401 of the IC device magazine 40 to on the heat plate 503 and moving IC devices on the heat plate 503 to on the loader buffer portion 502 and composed mainly of a Y-axis direction rail 501a, an X-axis direction rail 501b, a movable head portion 501c and a suction portion 501d. The loader section conveyor device 501 operates in a range including the supply tray stocker 401, heat plate 503 and two loader buffer sections 502.

As shown in FIG. 1, the two Y-axis direction rails 501a of the loader section conveyor device 501 are fixed to the base 12 of the handler 10, and between them is the X-axis direction rail 502b supported to be able to slide in the Y-axis direction. The X-axis direction rail 502b supports the movable head portion 501c having a Z-axis direction actuator (not shown) to be able to slide in the X-axis direction.

The movable head portion 501c is provided with four suction portions 501d each having a suction pad 501e at its lower end portion and able to move the four suction portions 501d upward and downward in the Z-axis direction separately by driving the Z-axis direction actuator.

Each of the suction portions 501d is connected to a negative-pressure source (not shown), capable of picking up and holding an IC device by generating a negative pressure by drawing air from the suction pad 501e and releasing the IC device by stopping drawing air from the suction pad 501e.

The heat plate 503 is a heat source for applying a predetermined thermal stress to IC devices and, for example, a metal heat transfer plate having a heat source (not shown) at its lower part. On an upper surface of the heat plate 503, a plurality of recessed portions 503a for being dropped IC devices are formed. Note that a cooling source may be provided instead of the heat source.

The loader buffer portion 502 is a device for moving IC devices back and forth between an operation range of the loader section conveyor device 501 and an operation range of the test section conveyor device 310 and mainly comprises a buffer stage 502a and an X-axis direction actuator 502b.

The buffer stage 502a is supported at one end portion of the X-axis direction actuator 502b fixed to the base 12 of the handler 10 and, as shown in FIG. 1, four recessed portions 502c having a rectangular shape when seeing two dimensionally for being dropped IC devices on the upper surface of the buffer stage 502a.

The pre-test IC devices are transferred from the supply tray stocker 401 to the heat plate 503 by the loader section conveyor device 501, heated to a predetermined temperature by the heat plate 503, then, transferred to the loader buffer portion 502 again by the loader section conveyor device 501 and introduced to the test section 30 by the loader buffer portion 502.

Test Section 30

The test section 30 is a part for conducting a test by bringing external terminals (soldering balls) 2a of the IC devices 2 to be tested electrically contact with the contact pins 301b of the sockets 301a of the contact portion 301. In the present embodiment, a socket inspection step is performed at predetermined timing. The test section 30 is configured to mainly comprise a test section conveyor device 310 and an image pickup device 314.

In the test section conveyor device 310, two X-axis direction supporting members 311a being able to slide in the Y-axis direction are supported by two Y-axis direction rails 311 fixed to the base 12 of the handler 10. The movable head portion 312 is supported at the center part of each of the X-axis direction supporting member 311a, and an operation range of the movable head portion 312 includes the loader buffer portions 502, the unloader buffer portion 602 and the test head 300. Note that the movable head portions 312 supported respectively by the two X-axis direction supporting members 311a operating at a time on a set of Y-axis direction rails 311 are controlled so as not to interfere with each other.

As shown in FIG. 3, each of the movable head portions 312 is provided with a first Z-axis direction actuator 313a, whose upper end is fixed to the X-axis direction supporting member 311a, a supporting base 312a fixed to a lower end of the first Z-axis direction actuator 313a, four second Z-axis direction actuators 313b, whose upper ends are fixed to the supporting base 312a, and four contact arms 315 fixed to lower ends of the second Z-axis direction actuators 313b. The four contact arms 315 are provided to be corresponding to an arrangement of the sockets 301a, and a lower end portion of each contact arm 315 is provided with a suction portion 317.

Each of the suction portions 317 is connected to a negative-pressure source (not shown) and capable of picking up and holding an IC device by drawing air from the suction portion 317 to generate a negative pressure and releasing the IC device by stopping drawing air from the suction portion 317.

Due to the movable head portions 312, it is possible to move four IC devices 2 held by the contact arms 315 in the Y-axis direction and Z-axis direction and press them against the contact portion 301 of the test head 300.

As shown in FIG. 3, the image pickup devices 314 are provided facing downward at one end of the supporting base 312a of the movable head portion 312. In the present embodiment, as shown in FIG. 1 and FIG. 2, a total of four image pickup devices 314 are provided, two to each movable head portion 312.

As the image pickup device 314, for example, a CCD camera may be used, but it is not limited to that and may be any as far as it is capable of taking an image of an object by being arrange with a large number of image pickup elements, such as a MOS (metal oxide semiconductor) sensor array. The image pickup device 314 is provided with a not shown lighting device, so that the sockets 301a as an image pickup object can be lighted brightly. Note that the respective image pickup devices 314 are connected to a not shown image processing apparatus.

As shown in FIG. 4, the contact portion 301 of the test head 300 is provided with four sockets 301a in the present embodiment, and the four sockets 301a are arranged to be substantially matched with an arrangement of contact arms 315 of the movable head portion 312 of the test section conveyor device 310. Furthermore, each socket 301a is provided with a plurality of contact pins 301b in an arrangement of being substantially matched with an arrangement of soldering balls 2a of an IC device 2.

As shown in FIG. 2, in the test section 30, an opening portion 11 is formed on the base 12 of the handler 10 and the contact portion 301 of the test head 300 comes out through the opening portion 11 so as to be pressed by an IC device.

Four pre-test IC devices loaded on the loader buffer portion 502 are moved to the contact portion 301 of the test head 300 by the test section conveyor device 301, subjected to a test at a time, then, moved to the unloader buffer portion 602 again by the test section conveyor device 310 and discharged to the unloader section 60 by the unloader buffer portion 602.

Unloader Section 60

The unloader section 60 is a part for taking out post-test IC devices from the test section 30 to the IC device magazine 40 and mainly comprises an unloader section conveyor device 601 and two unloader buffer portions 602 (two in the X-axis positive direction in FIG. 1).

The unloader buffer portion 602 is a device for moving IC devices back and forth between an operation range of the test section conveyor device 310 and an operation range of the unloader section conveyor device 601 and mainly comprises a buffer stage 602a and an X-axis direction actuator 602b.

The buffer stage 602a is supported at one end portion of the X-axis direction actuator 602b fixed on the base 12 of the handler 10, and four recessed portions 602c for being dropped IC devices are formed on an upper surface of the buffer stage 602a.

The unloader section conveyor device 601 is a device for moving and loading IC devices on the unloader buffer section 602 to the classification tray of the classification tray stocker 402 and mainly comprises a Y-axis direction rail 601a, an X-axis direction rail 601b, a movable head portion 601c and a suction portion 601d. An operation range of the unloader section conveyor device 601 includes two unloader buffers 602 and classification tray stocker 402.

As shown in FIG. 1, two Y-axis direction rails 601a of the unloader section conveyor device 601 are fixed to the base 12 of the handler 10, and the X-axis rail 602b is supported to be able to slide in the Y-axis direction between them. The X-axis direction rail 602b supports a movable head portion 601c provided with a Z-axis direction actuator (not shown) to be able to slide in the X-axis direction.

The movable head portion 601c is provided with four suction portions 601d, each having a suction pad at its lower end portion and able to move the four suction portions 601d upward and downward in the Z-axis direction separately by driving the Z-axis direction actuator.

Post-test IC devices loaded on the unloader buffer portion 602 are discharged from the test section 30 to the unloader section 60 and loaded on classification trays of the classification tray stocker from the unloader buffer portion 602 by the unloader section conveyor device 601.

The handler 10 according to the present embodiment is also provided with a control unit for controlling a variety of operations of the handler 10 and counting the number of tests, an image processing apparatus for performing processing on image data obtained from the image pickup device 314, a memory device for storing standard image data of the sockets 301a and an alarm device, such as a speaker, buzzer and an alarm light (none of them are shown).

Next, an operation flow of transfer and test in the handler 10 explained above will be explained.

First, the loader section conveyor device 501 uses the suction pads 501e of the four suction portions 501d to pick up and hold four IC devices on the supply tray positioning at the uppermost level of the supply tray stocker 401 of the IC device magazine 40.

The loader section conveyor device 501 elevates the four IC devices by the Z-axis direction actuator of the movable head 501c while holding the four IC devices and moves them by sliding the X-axis direction rail 501b on the Y-axis direction rail 501a and sliding the movable head portion 501c on the X-axis direction rail 501b.

Then, the loader section conveyor device 501 performs alignment above the recessed portions 503a on the heat plate 503, extends the Z-axis direction actuator of the movable head portion 501c, and releases the suction pads 501e to drop the IC devices into the recessed portions 503a on the heat plate 503. When the IC devices are heated to a predetermined temperature by the heat plate 503, the loader section conveyor device 501 again holds the heated four IC devices and moves to above one of the loader buffer portions 502 standing by.

The loader section conveyor device 501 performs alignment above the buffer stage 502a of the standby loader buffer portions 502, extends the Z-axis direction actuator of the movable head portion 501c, and releases the IC devices 2 picked up and held by the suction pads 501e of the suction portion 501d to put the IC devices 2 into the recessed portions 503c on the buffer stage 502a.

The loader buffer portion 502 extends the X-axis direction actuator 502b while carrying the four IC devices 2 in the recessed portions 502c on the buffer stage 502a and moves the four IC devices 2 from an operation range of the loader section conveyor device 501 of the loader section 50 to an operation range of the test section conveyor device 310 of the test section 30.

When the buffer stage 502a loaded with the IC devices 2 moves into the operation range of the test section conveying device as explained above, the movable head portion 312 of the test section conveyor device 310 moves to above the IC devices 2 placed in the recessed portions 502c on the buffer stage 502a. Then, the first Z-axis direction actuator 313a of the movable head portion 312 extends, and the suction portions 317 of the four contact arms 315 of the movable head portion 312 pick up and hold the four IC devices placed in the recessed portions 502c on the buffer stage 502a of the loader buffer portion 502.

The movable head portion 312 holding the four IC devices elevate by the first Z-axis direction actuator 313a of the movable head portion 312.

Next, the test section conveyor device 310 slides the X-axis direction supporting member 311a supporting the movable head portion 312 on the Y-axis direction rail 311 and conveys the four IC devices 2 held by the suction portions 317 of the contact arms 315 of the movable head portion 312 to above the four sockets 301a at the contact portion 301 of the test head 300.

The movable head portion 312 extends the first Z-axis direction actuator 313a and the second Z-axis direction actuator 313b holding the IC devices 2 to bring soldering balls 2a of each IC device 2 contact the contact pins 301b of the sockets 301a. During the contact, an electric signal is exchanged via the contact pins 301b and a test is conducted on the IC devices 2.

When the test on the IC devices 2 is completed, the test section conveyor device 301 elevates the post-test IC devices 2 by contracting the first Z-axis direction actuator 313a and the second Z-axis direction actuator 313b of the movable head portion 312, makes the X-axis direction supporting member 311a supporting the movable head portion 312 slide on the Y-axis direction rail 311 and conveys the four IC devices 2 held by the contact arms 315 of the movable head portion 312 to above the buffer stage 602a of one unloader buffer portion 602 standing by in the operation range of the test section conveyor device 310.

The movable head portion 312 extends the first Z-axis direction actuator 313a and releases the suction pads 317c, so that the four IC devices are dropped into the recessed portions 602c of the buffer stage 602a.

The unloader buffer portion 602 drives the X-axis actuator 602b while carrying the four post-test IC devices and moves the IC devices from the operation range of the test section conveyor device 310 of the test section 30 to the operation range of the unloader section conveyor device 601 of the unloader section 60.

Next, the Z-axis direction actuator of the movable head portion 601c of the unloader section conveyor device 601 positioning above the unloader buffer portion 602 is extended, and four suction portions 601d of the movable head portion 601c pick up and hold the four post-test IC devices placed in the recessed portions 602c of the buffer stage 602a of the unloader buffer portion 602.

The unloader section conveyor device 601 elevates the four IC devices by the Z-axis direction actuator of the movable head portion 601c while carrying the four post-test IC devices, slides the X-axis direction rail 601b on the Y-axis direction rail 601a and slides the movable head portion 601c on the X-axis direction rail 601b so as to move them to above the classification tray stocker 402 of the IC device magazine 40. Then, the respective IC devices are loaded on classification trays each positioning at the uppermost level of the classification tray stockers 402 in accordance with the test results of the IC devices.

As explained above, a test on the IC devices is conducted once.

Next, a socket inspection step in the handler 10 explained above will be explained.

When inspecting sockets 301a, standard image data of sockets 301a in a good condition without any defects is obtained and stored in the memory device prior to the test of IC devices as explained above.

Specifically, a test head 300 having a contact portion 301 provided with sockets 301a in a good condition without any defects is set to the handler 10, then, the image pickup device 314 is conveyed to above the sockets 301a to take an image of the respective sockets 301a and it is stored as standard image data in the memory device (refer to a standard image in FIG. 5).

Below, the socket inspection step will be explained with reference to the flowcharts in FIG. 4.

The handler 10 counts the number of test times while transferring and testing IC devices as explained above. Namely, when the handler 10 conveys and tests IC devices (Step 01), it adds “1” to the stored test times (Step 02), and determines whether or not the result as the test times is a predetermined value “N” or larger (Step 03). The predetermined value “N” can be set, for example, by assuming timing of a defect arising to the sockets 301a. As a result, an inspection of the sockets 301a can be performed efficiently.

Note that after the IC devices physically contact the sockets 301a, normally, a contact test is conducted prior to a device test. As a result, it is possible to confirm whether all or specific contact pins 301b are electrically connected to corresponding external terminals of the IC devices or not. When a contact defect is detected in this contact test, the physical contact operation of the IC devices and sockets 301a is retried, then, en electric contact test is performed. When a contact defect is detected after times (for example 5 times) of the contact operation, it is considered that it is caused by a defect on the IC device side or a defect on the socket 301a side, so that a test on that IC device is not conducted. In that case, it is preferable that, regardless of a value of “N”, the socket inspection step is forcibly performed to find out whether it is a defect on the socket 301a side or not.

When the number of tests is determined to be less than the predetermined value “N” (Step 03-No), the handler 10 repeats transfer and test of IC devices (Step 01). On the other hand, when the number of tests is determined to be a predetermined value “N” or larger (Step 03-Yes), the handler 10 stops the conveying operation of IC devices (Step 04), slides the X-axis direction supporting member 311a supporting the movable head portion 312 on the Y-axis direction rail 311 and moves the image pickup device 314 to above the sockets 301a (Step 05: refer to FIG. 3).

Then, the handler 10 takes an image of the sockets 301a by the image pickup device 314 (Step 06) and obtains inspection image data (Step 07: refer to the inspection image in FIG. 5). At this time, the lighting device of the image pickup device 314 lights the sockets 301a brightly. By moving the movable head portion 312 in the Y-axis direction, the image pickup device 314 takes images of two sockets 301a being adjacent in the Y-axis direction (two sockets 301a on the right and left in FIG. 3), respectively. Note that the sockets 301a as an inspection object in FIG. 5 has missing of contact pins 301b, dirt on a contact pin 301b due to shifting of soldering, a soldering ball and a rectangular plate as foreign matters.

The image processing apparatus of the handler 10 reads the standard image data from the memory device (Step 08) and corrects a pixel value (brightness) of the standard image data to be matched with that of the obtained inspection image data explained above (Step 09: refer to an image at the center on the upper position in FIG. 5). By performing such pixel value correcting processing, it becomes possible to detect a defective part of the socket with high accuracy and detection of a socket defect can be stably performed. Note that a pixel value of the obtained inspection image data may be corrected to be matched with that of the standard image data while leaving the pixel value of the standard image data as it is if desired.

The image processing apparatus of the handler 10 performs difference processing between the standard image data subjected to the pixel value correcting processing and the inspection image data to generate a differential image (Step 10: refer to a differential image in FIG. 5) and performs threshold processing on the differential image (Step 11). Then, the image processing apparatus determines a defective part of the sockets 301a based on whether there is a part exceeding a threshold value in the differential image or not (Step 12).

When the image processing apparatus of the handler 10 determines that there is no defective part in the socket 301a (Step 13-No), the handler 10 resets the number of tests to “0” (Step 14) and repeats transfer and test of IC devices again (Step 01).

On the other hand, when the image processing apparatus of the handler determines that there is a defective part in the sockets 301a (Step 13-Yes), the handler 10 activates an alarm device (Step 15) and leaves the transfer and test of the IC devices stopped. Note that if desired, data of the differential image (refer to FIG. 5) may be transmitted to the image display device at the time of activating the alarm device so as to display on the monitor of the external image display device. Alternately, XY positional information of respective contact pins 301b may be obtained from the standard image data in advance and an XY position of the defective part may be determined from the differential image data so as to specify a pin number of a contact pin 301b having the defective part for displaying the same on the monitor of the image display device.

It becomes possible for an operator to know by the alarm device that there is a defective part in sockets 301a, so that the defective part of the sockets 301a can be resolved. Also, in that case, transfer and test of IC devices are automatically suspended, so that it is possible to prevent tests on IC devices after that from being conducted under the socket defective condition.

Here, an example of setting the predetermined value “N” on the number of test times will be explained. A suitable value of “N” widely differs depending on conditions of a shape of the sockets 301a, configuration of the contact pins, the number of pins and pitches of arrangement of external terminals of an IC device, etc. and it may be changed from the initially set value based on the inspection result. As an example, it is assumed that the initial predetermined value “N” is 300. In that case, the socket inspection step is performed at the number of test times of 300. When it is determined that there is no defective part by performing the inspection, the “N” value is changed to a value, for example, obtained by increasing 10%, (300+30). Inversely, when determined that there is a defective part by performing the inspection, the “N” value is updated to a value, for example, obtained by reducing 20%, (300-60). Due to this, the frequency of performing the socket inspection step can be optimized, consequently, a decline of the throughput of the device tests can be suppressed to the minimum. Also, if desired, the “N” value at the time of arising a defect in the contact test may be updated to a value obtained by reducing 10%, (300-30).

According to the handler 10 for operating the socket inspection as explained above, it is possible to automatically detect defects, such as a missing of a contact pin 301b of a socket 301a, dirt on a contact pin 301b due to shifting of soldering, etc., wear and deformation of a contact pin 301b and existence of soldering balls or other foreign matters. Therefore, it becomes unnecessary to take out sockets 301a from the test head 300 to observe by a microscope regularly, so that interruption time of the tests can be reduced and the test efficiency and, moreover, productivity of IC devices can be improved. Also, it is surely eliminated to determine an originally good device as a defect or damage a good device to make it defective because of defective contact pins 301b, so that test quality in the electronic device testing apparatus 1 can be improved.

The embodiments explained above are described to facilitate understanding of the present invention and is not to limit the present invention. Accordingly, respective elements disclosed in the above embodiments include all design modifications and equivalents belonging to the technical scope of the present invention.

For example, in the handler 10 according to the above embodiment, the socket inspection was performed based on the number of test times of IC devices, but the present invention is not limited to that and, for example, the number of contact defects in the test may be counted and the socket inspection may be performed when the counted number of contact defects becomes a predetermined value or larger. Note that information on the contact defects can be obtained from the result of tests on the IC devices. The predetermined value may be set on an assumption of timing with high probability that a defect arises in sockets 301a. Consequently, inspection of the sockets 301a can be efficiently performed.

Also, in the handler 10 according to the above embodiment, four image pickup devices 314 were provided as an example, but it may be configured to provide the image pickup device 314 to one of two movable head portions 312. Also, it may be configured to provide one image pickup device 314 to a independent moving mechanism separately from that of the movable head portion 312 and take an image of respective sockets 301a by moving the image pickup device 314 in the X-axis and Y-axis directions.

Also, if desired, an inspection step of insulation resistance between pins may be added between the Step 04 and Step 05 explained above. For example, insulation resistance between respective contact pins 301b may be measured successively on all pins and, when a predetermined resistance value or lower (for example, 10MΩ or lower) is detected, an alarm of an insulation defect may be notified to the outside. According to this, it is possible to detect arising of an insulation defect due to an existence of soldering dust, etc. between adjacent contact pins 301b. As a result, a problem that an originally good device is determined as a defect can be eliminated.

Also, when the handler 10 is provided with a cleaning device (for example, a sweeping type removal device of dusts, etc. by a brush mechanism or a pneumatic pressure) capable of cleaning the contact pins 301b of the sockets 301a, it is preferable that cleaning processing is performed at least on the sockets 301a or contact pins 301b having a detected defect and, then, the Step 05 is performed again after the cleaning processing to perform the processing routine of whether the defect is eliminated or not is performed at least once. According to this, a light defective state caused by dusts, etc. on the sockets may be recovered, so that an operation rate of the electronic device testing apparatus 1 can be improved.

Also, in the above embodiment, as an example, transfer and test of IC devices were suspended after setting off the alarm device in the Step 15, but the test may be continued only with good sockets. For example, picking up and transfer may be controlled by not placing an IC device in a recessed portion 502c on the loader buffer portion 502 corresponding to a position of the detected defect socket and placing IC devices in recessed portions 502c corresponding to positions of good sockets. Note that it is preferable to alarm and notify of the defective socket even in this case. Due to this, tests can be continuously conducted only with valid good sockets without interrupting the device tests, so that an operation rate of the electronic device testing apparatus 1 can be improved.

Also, the image display device may be provided near the handler 10 or to a central control center on a network. In that case, information indicating a defective part detected by the defect detection means may be displayed on the image display device. For example, a standard image of the socket 301a or a pin layout and pin numbers of the sockets 301a may be displayed and an image of the defective part (a colored image, contour image and enhanced image, etc.) may be superimposed thereon to be displayed (an overlay display), or the both may be switched alternately to be displayed so that the positional relationship of the defective part can be understood. Furthermore, if desired, a cursor or a marker for pointing the defective part may be displayed on the screen and a pin number of a point pointed by the operator or XY positional information of the socket may be displayed by values, or the defective part may be partially enlarged to be displayed. According to this, a condition of the defective part can be perceived obviously at a glance.

### INDUSTRIAL APPLICABILITY

The electronic device handling apparatus of the present invention is useful for automatically detecting a defect of a socket without requiring a visual exterior inspection.

1. An electronic device handling apparatus for conducting a test of electric characteristics of electronic devices by conveying the electronic devices to sockets of a contact portion and bringing them electrically connected to the sockets, comprising:
an image pickup device for taking an image of the sockets;
a memory device for storing standard image data as image data of the sockets to be a standard obtained by taking an image by said image pickup device; and
a defect detection means for obtaining inspection image data as image data of sockets as inspection objects by taking an image by said image pickup device, reading standard image data from said memory device and detecting a defect of a socket as inspection objects by comparing the standard image data with said inspection image data.

2. The electronic device handling apparatus as set forth in claim 1, wherein said electronic handling apparatus furthermore comprises an alarm device, and said alarm device is activated when a defect of a socket as an inspection object is detected by said defect detection means.

3. The electronic device handling apparatus as set forth in claim 1, wherein said electronic device handling apparatus furthermore comprising a count means for counting the number of test times of electronic devices, and said image pickup device takes an image of sockets as inspection objects when the number of test times counted by said count means becomes a predetermined value or larger.

4. The electronic device handling apparatus as set forth in claim 1, wherein said electronic device handling apparatus furthermore comprises a count means for counting the number of contact defects in tests, and said image pickup device takes an image of sockets as inspection objects when the number of contact defects counted by said count means becomes a predetermined value or larger.

5. The electronic device handling apparatus as set forth in claim 1, wherein said defect detection means generates differential image data by performing difference processing on said standard image data and said inspection image data and performs threshold processing on said differential image data so as to detect a defect of a sockets as an inspection object.

6. The electronic device handling apparatus as set forth in claim 5, wherein said defect detection means performs pixel value correction of said standard image data by making it matched with said inspection image data before performing said difference processing.

7. The electronic device handling apparatus as set forth in claim 1, wherein:
said electronic device handling apparatus furthermore comprises a conveyor device capable of holding an electronic device to be tested and pressing it against said sockets; and
said image pickup device is attached to said conveyor device.

8. An electronic device handling apparatus for conducting a test of electric characteristics of electronic devices by conveying the electronic devices to sockets of a contact portion and bringing them electrically connected to the sockets, comprising:
an image pickup device for taking an image of all contact pins of the sockets; and
a defect detection means for taking an image of all contact pins of initial sockets and storing as standard image data, taking all contact pins of sockets as inspection image data every time a predetermined number of test times comes, and detecting a defect of a socket based on said standard image data and said inspection image data.

9. The electronic device handling apparatus as set froth in claim 1 or 8, wherein said defect detection means corrects brightness, so that brightness on said standard image data and brightness on said inspection image data side become approximately the same, then, obtains a brightness difference of corresponding pixel positions of the two, and determines a defect of the sockets based on an existence of a image part, wherein the obtained brightness difference exceeds a predetermined threshold value.

10. The electronic device handling apparatus as set froth in claim 1 or 8, wherein, when a defect of a socket is detected by said defect detection means, transfer of an electronic device to the defect socket is terminated while transfer of electronic devices to other normal sockets and tests thereon continue.

11. The electronic device handling apparatus as set froth in claim 1 or 8, wherein:
said electronic device handling apparatus furthermore comprises a display device;
an image of sockets is displayed on said display device; and
information indicating a defect detected by said defect detection means is displayed by being superimposed on a position corresponding to the defect part of the image of said sockets.
